(19) United States
(12) Patent Application Publication
(10) Pub. No.: US 2013/0128134 A1
(43) Pub. Date: May 23, 2013

(54) TOUCH LIQUID CRYSTAL DISPLAY AND MANUFACTURING METHOD THEREOF

(71) Applicant: Hsin-Hung WU, Pingtung City (TW)

(72) Inventor: Hsin-Hung WU, Pingtung City (TW)

(73) Assignee: HANNSTAR DISPLAY CORP., New Taipei City (TW)

(21) Appl. No.: 13/563,907

(22) Filed: Aug. 1, 2012

(30) Foreign Application Priority Data
Nov. 23, 2011 (TW) 100142856

(51) Int. Cl. G02F 1/13357; H01J 9/24

(52) U.S. Cl. 349/12; 445/24

(57) ABSTRACT

There is provided a touch liquid crystal display including a backlight unit, a display unit and a touch panel. The display unit includes a first substrate, a second substrate and a driver chip, wherein the second substrate and the driver chip are disposed on a front side of the first substrate. The front side of the first substrate is attached to the backlight unit in edges thereof using an adhesive, and the touch panel is attached to a back side of the first substrate using a hydrogel. There is further provided a manufacturing method of a touch liquid crystal display.

### CROSS REFERENCE TO RELATED APPLICATION

This application claims the priority benefit of Taiwan Patent Application Serial Number 100142856, filed on Nov. 23, 2011, the full disclosure of which is incorporated herein by reference.

### Background

1. Field of the Disclosure

This disclosure generally relates to a display device and, more particularly, to a touch liquid crystal display.

2. Description of the Related Art

Conventional human machine interface systems have to use an additional peripheral device such as a mouse, a keyboard and so on to interact with a host. Recently, as touch panel technologies have become mature and the touch panel itself has the merit of having an easy operation and an integral structure, the touch panel is gradually used to replace conventional peripheral devices and applied to various electronic products.

For example referring to FIG. 1, it shows an explosion diagram of a conventional touch liquid crystal display 9 which includes a backlight module 92, a display unit 94, a front bezel 96 and a touch panel 98. The backlight module 92 includes a lower bezel 922 and a light emitting unit 924, wherein the lower bezel 922 is configured to be combined with the front bezel 96 so as to maintain the combination of the backlight module 92 and the display unit 94. The display unit 94 includes a thin film transistor substrate 942, a color filter substrate 944 and a driver chip 946, wherein the color filter substrate 944 and the driver chip 946 are formed on a front side of the thin film transistor substrate 942, and the display unit 94 further has a display area 948 for displaying images. The front bezel 96 has an opening corresponding to the display area 948 of the display unit 94. The touch panel 98 is attached to the front bezel 96 in edges thereof.

Please refer to FIG. 2, it shows a cross-sectional view taken alone the line II-II′ of the touch liquid crystal display 9 shown in FIG. 1, wherein the light emitting unit 924, the thin film transistor substrate 942, the color filter substrate 944 and the driver chip 946 are integrated and fixed inside the lower bezel 922 and the front bezel 96, and the touch panel 98 is attached to the front bezel 96 in edges thereof using a twin adhesive laminator 99. In the conventional touch liquid crystal display 9, as the front bezel 96 has a thickness and the opening 968, a bottom surface 98S of the touch panel 98 is not able to tightly attached to the color filter substrate 944 when the touch panel 98 is attached to the front bezel 96 such that a gap 90 can exist between the touch panel 98 and the color filter substrate 944. As the gap 92 is filled with air, the transparency and the color saturation of the touch liquid crystal display 9 can be degraded, and further the structure strength is decreased thereby shortening the lifetime. In addition, as the backlight module 92 of the conventional touch liquid crystal display 9 has to use the lower bezel 922 and the front bezel 96 as a combination means, it has a relatively larger size.

Accordingly, it is necessary to provide a touch liquid crystal display that can overcome the problems of the low transparency, low color saturation and low structure strength caused in the system manufacturing mentioned above.

### SUMMARY

It is an object of the present disclosure to provide a touch liquid crystal display and manufacturing method thereof in which a backlight module having a bezel is not employed so as to decrease a size of the backlight module.

It is another object of the present disclosure to provide a touch liquid crystal display and manufacturing method thereof that may improve the brightness, the color saturation and the structure strength.

The present disclosure provides a touch liquid crystal display including a display unit, a backlight unit and a touch panel. The display unit includes a first substrate, a second substrate and a driver chip, wherein the first substrate has a front side and a back side opposite to each other, and the second substrate and the driver chip are disposed on the front side of the first substrate. The backlight unit is configured to provide light needed by the display unit in displaying images, and the backlight unit is attached to the front side of the first substrate in edges thereof using an adhesive. The touch panel has a bottom surface which is attached to the back side of the first substrate using a hydrogel.

The present disclosure further provides a manufacturing method of a touch liquid crystal display including the steps of: providing a display unit which has a first substrate, a second substrate and a driver chip, wherein the second substrate and the driver chip are disposed on a front side of the first substrate; providing a backlight unit; attaching the front side of the first substrate to the backlight unit in edges thereof using an adhesive; and attaching a touch panel to a back side of the first substrate using a hydrogel.

In the touch liquid crystal display and the manufacturing method of the present disclosure, the first substrate is a thin film transistor substrate and the second substrate is a color filter substrate; and a display area of the display unit is on the back side of the first substrate.

In the touch liquid crystal display of the present disclosure, as the touch panel and the display unit are combined together using a hydrogel, the touch liquid crystal display may have the merit of having a high brightness, a high color saturation and a high structure strength.

### BRIEF DESCRIPTION OF THE DRAWINGS

Other objects, advantages, and novel features of the present disclosure will become more apparent from the following detailed description when taken in conjunction with the accompanying drawings.

FIG. 1 shows an explosion diagram of a conventional touch liquid crystal display.

FIG. 2 shows a cross-sectional view taken alone the line II-II′ of the touch liquid crystal display shown in FIG. 1.

FIG. 3 shows a cross-sectional view of the touch liquid crystal display according to an embodiment of the present disclosure.

FIG. 4 shows an explosion diagram of the touch liquid crystal display according to an embodiment of the present disclosure.

FIG. 5 shows a flow chart of the manufacturing method of the touch liquid crystal display according to an embodiment of the present disclosure.

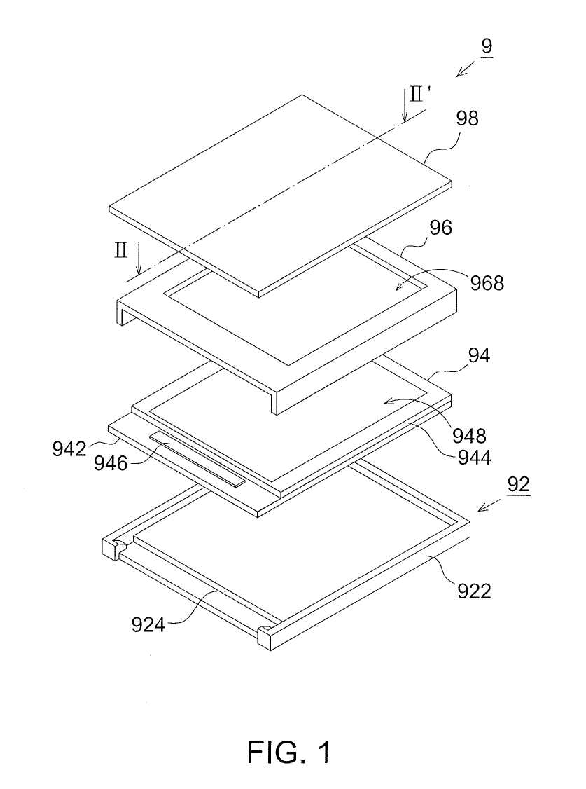

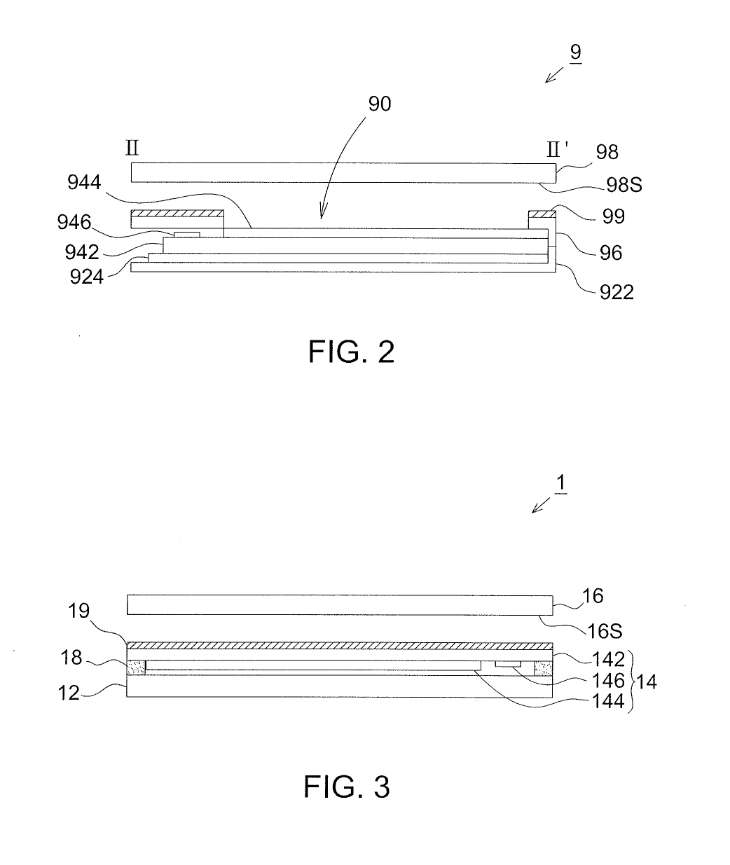

### DETAILED DESCRIPTION OF THE EMBODIMENT

It should be noted that, wherever possible, the same reference numbers will be used throughout the drawings to refer to the same or like parts.

Meanwhile, the drawings of the present disclosure only show a part of components and omit the components that are not directly pertinent to the present disclosure.

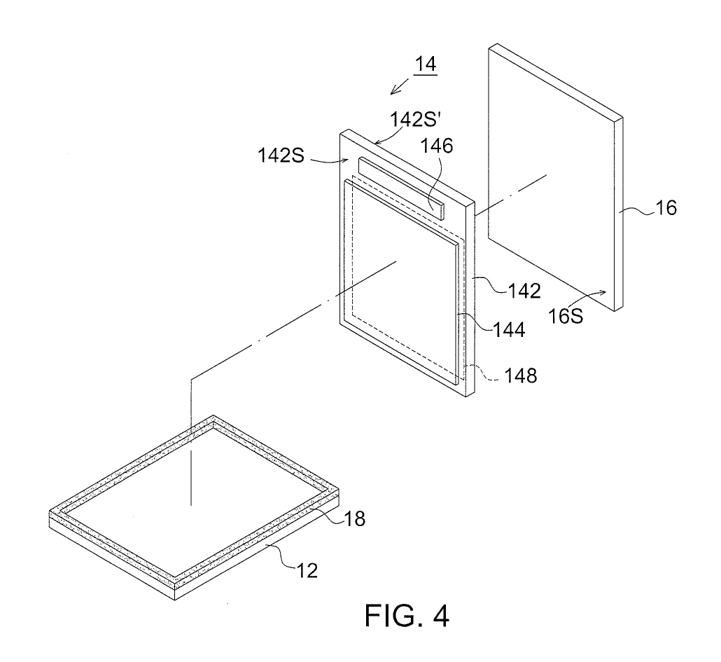

Please refer to FIGS. 3 and 4, FIG. 3 shows a cross-sectional view of the touch liquid crystal display according to an embodiment of the present disclosure and FIG. 4 shows an explosion diagram of the touch liquid crystal display according to an embodiment of the present disclosure. The touch liquid crystal display 1 includes a backlight unit 12, a display unit 14 and a touch panel 16. The backlight unit 12 is configured to provide light needed by the display unit 14 in displaying images and may include a light source, optical films, a light guiding plate, a reflecting plate and so on. As the manufacturing and the structure of the backlight unit are well known to the art, details thereof are not described herein.

The display unit 14 includes a first substrate 142, a second substrate 144 and a driver chip 146, wherein the first substrate 142 may be a thin film transistor substrate and the second substrate 144 may be a color filter substrate, and the second substrate 142 is opposite to the first substrate 142. The second substrate 144 and the driver chip 146 are respectively disposed on a front side 142S of the first substrate 142 and facing the backlight unit 12, wherein a part of one edge on the front side 142S of the first substrate 142 is not covered by the second substrate 144 for disposing the driver chip 146; for example, the driver chip 146 is formed on the front side 1425 of the first substrate 142 using a chip on glass (COG) process. In addition, a part of the rest three edges on the front side 142S of the first substrate 142 is not covered by the second substrate 144. The edges on the front side 142S of the first substrate 142 of the display unit 14 is attached to the edges of the backlight unit 12 using an adhesive 18, wherein the adhesive 18 may be a twin adhesive laminator or a stripe shaped adhesive attached to the edges of the front side 142S and/or the backlight unit 12. It is appreciated that a liquid crystal layer is sandwiched between the first substrate 142 and the second substrate 144 configured to control the amount of light passing through. As the front side 142S of the first substrate 142 and the backlight unit 12 are attached together in the edges thereof using the adhesive 18, an area of the second substrate 144 is preferably smaller than that of the first substrate 142. In addition, to prevent the second substrate 144 and the driver chip 146 in contact with the backlight unit 12, a thickness of the adhesive 18 is preferably larger than that of the second substrate 144 and the driver chip 146. A display area 148 of the display unit 14 is located on a back side 142S′ of the first substrate 142. It is appreciated that the driver chip 146 is electrically coupled to the first substrate 142 and the second substrate 144.

A bottom surface 16S of the touch panel 16 is attached to the back side 142S′ of the first substrate 142 of the display unit 14 using a hydrogel 19, e.g. LOCA. In this manner, there is no air dielectric existing between the touch panel 16 and the display unit 14 and there is only the hydrogel 19 existing therebetween. Based on the optical feature of the hydrogel 19, it is able to significantly improve the display brightness and the color saturation. In addition, as there is no gap existing between the touch panel 16 and the display unit 14, the touch panel 16 can be tightly attached to the display unit 14 thereby significantly improving the structure strength and extending the lifetime.

It is appreciated that thicknesses of the adhesive 18 and the hydrogel 19 shown in FIG. 3 are only exemplary and not used to limit the present disclosure.

In the touch liquid crystal display 1 of this embodiment, structures of the backlight unit 12, the display unit 14 and the touch panel 16 themselves have no particular limitation, and the spirit of the present disclosure is on the manufacturing method of combining the backlight unit 12, the display unit 14 and the touch panel 16 so as to improve the brightness, the color saturation and the structure strength. And since no bezel is used in the structure of this embodiment, the size of the backlight unit can be significant reduced. In other words, as the conventional backlight module needs to use a bezel, it has a relatively larger size. An area of the backlight unit 12 may be substantially identical to that of the display unit 14 in this embodiment.

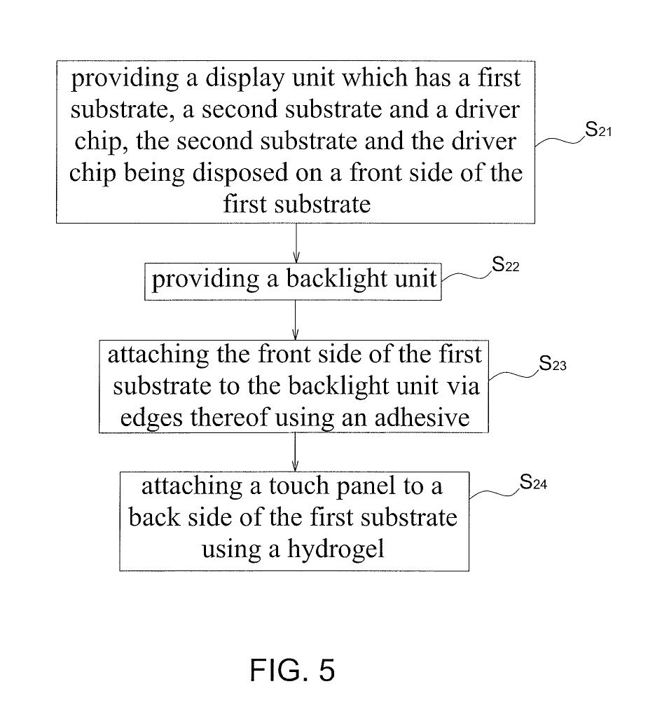

Please refer to FIGS. 4 and 5, FIG. 5 shows a flow chart of the manufacturing method of the touch liquid crystal display 1 according to an embodiment of the present disclosure. The manufacturing method includes the steps of: providing a display unit which has a first substrate, a second substrate and a driver chip, wherein the second substrate and the driver chip are disposed on a front side of the first substrate (Step S₂₁); providing a backlight unit (Step S₂₂); attaching the front side of the first substrate to the backlight unit in edges thereof using an adhesive (Step S₂₃); and attaching a touch panel to a back side of the first substrate using a hydrogel (Step S₂₄).

In Step S₂₁, the first substrate 142, the second substrate 144 and the driver chip 146 may be previously manufactured as a liquid crystal display unit, but the manufacturing of the liquid crystal display unit is not an object of the present disclosure and details thereof are not described herein.

In Step S₂₂, the backlight unit may be made previously using a light source, optical films, a light guiding plate, a reflecting plate (not shown) and so on, but the manufacturing method thereof is not an object of the present disclosure and details thereof are not described herein. In should be mentioned that in this embodiment the backlight unit 12 does not include any bezel.

In Step S₂₃, the front side 142S of first substrate 142 is attached to the backlight unit 12 in edges thereof using the adhesive 18. It is appreciated that in this step, the adhesive 18 may be previously attached to edges of the backlight unit 12 or to edges of the front side 142S of the first substrate 142 and then the display unit 14 is attached to the backlight unit 12, wherein the adhesive may be attached to a part of opposite edges or all of the edges of the backlight unit 12, or attached to a part of opposite edges or all of the edges of the front side 142S of the first substrate 142.

In Step S₂₄, the bottom surface 16S of the touch panel 16 is attached to the back side 142S′ of the first substrate 142 using the hydrogel 19, and the bottom surface 16S is tightly attached to the back side 142S′ without any gap existing therebetween. It is appreciated that in this step, the hydrogel 19 may be previously spread over the bottom surface 16S of the touch panel 16 or the back side 142S′ of the first substrate 142 and then the touch panel 16 is attached to the display unit 14, wherein the hydrogel 19 may be spread over at least a part of or all of the bottom surface 16S of the touch panel 16, or over at least a part of or all of the back side 142S′ of the first substrate 142.

As mentioned above, the conventional touch liquid crystal display has to use a bezel in manufacturing such that a size of the backlight module is increased, and since the bezel has a thickness, the touch panel is unable to tightly attached to the display unit and a gap can exist between the touch panel and the display unit. Therefore, the present disclosure further provides a touch liquid crystal display without a bezel (FIGS. 3 and 4), wherein a combination interface of the touch panel and the display unit is a hydrogel rather than the air such that the display brightness and the color saturation can be significantly improved. And because the touch panel and the display unit are tightly attached to each other, the structure strength is significantly increased as well.

Although the disclosure has been explained in relation to its preferred embodiment, it is not used to limit the disclosure. It is to be understood that many other possible modifications and variations can be made by those skilled in the art without departing from the spirit and scope of the disclosure as hereinafter claimed.

What is claimed is:

1. A touch liquid crystal display, comprising:
a display unit comprising a first substrate, a second substrate and a driver chip, the first substrate having a front side and a back side opposite to each other, the second substrate and the driver chip being disposed on the front side of the first substrate;
a backlight unit configured to provide light needed by the display unit in displaying images, the backlight unit being attached to the front side of the first substrate in edges thereof using an adhesive; and
a touch panel having a bottom surface which is attached to the back side of the first substrate using a hydrogel.

2. The touch liquid crystal display as claimed in claim 1, wherein the adhesive is attached at a part of opposite edges or all of the edges of the backlight unit and the front side of the first substrate; and the hydrogel is spread over at least a part of or all of the bottom surface of the touch panel and the back side of the first substrate.

3. The touch liquid crystal display as claimed in claim 1, wherein the first substrate is a thin film transistor substrate and the second substrate is a color filter substrate.

4. The touch liquid crystal display as claimed in claim 1, wherein a display area of the display unit is on the back side of the first substrate.

5. The touch liquid crystal display as claimed in claim 1, wherein the driver chip is formed on the front side of the first substrate using a chip-on-glass process.

6. A manufacturing method of a touch liquid crystal display, comprising:
providing a display unit which comprises a first substrate, a second substrate and a driver chip, the second substrate and the driver chip being disposed on a front side of the first substrate;
providing a backlight unit;
attaching the front side of the first substrate to the backlight unit in edges thereof using an adhesive; and
attaching a touch panel to a back side of the first substrate using a hydrogel.

7. The manufacturing method as claimed in claim 6, before the step of attaching the front side of the first substrate to the backlight unit further comprising:
attaching the adhesive to a part of opposite edges or all of the edges of the front side of the first substrate, or to a part of opposite edges or all of the edges of the backlight unit.

8. The manufacturing method as claimed in claim 6, before the step of attaching a touch panel to a back side of the first substrate further comprising: spreading the hydrogel over at least a part of or all of a bottom surface of the touch panel, or over at least a part of or all of the back side of the first substrate.

9. The manufacturing method as claimed in claim 6, wherein the first substrate is a thin film transistor substrate and the second substrate is a color filter substrate.

10. The manufacturing method as claimed in claim 6, wherein a display area of the display unit is on the back side of the first substrate.
